(19) United States
(12) Patent Application Publication
(10) Pub. No.: US 2003/0204444 A1
(43) Pub. Date: Oct. 30, 2003

(54) Method and apparatus for managing and providing offers

(76) Inventors: Andrew S. Van Luchene, New York, NY (US); Raymond J. Mueller, Weston, CT (US); Christine Amorissi, Brookfield, CT (US)

Correspondence Address: WALKER DIGITAL, FIVE HIGH RIDGE PARK, STAMFORD, CT, 06905, US

(21) Appl. No.: 10/403,184

(22) Filed: Mar. 28, 2003

Related U.S. Application Data
(60) Provisional application No. 60/369,108, filed on Mar. 29, 2002.
(60) Provisional application No. 60/444,250, filed on Jan. 30, 2003.

(51) Int. Cl. G06F 17/60

(52) U.S. Cl. 705/16

(57) ABSTRACT

An apparatus for managing and providing offers includes a mechanism that identifies one or more a transaction slots and determines whether to provide one or more offers during those transaction slots. The apparatus further includes a component operable to create such offers and a component for providing such offers to customers. The apparatus further includes a method to optimize the results of such offers over time to maximize system performance.

This application claims the benefit of priority of the following U.S. Provisional Patent Applications:

U.S. Provisional Patent Application No. 60/369,108, filed Mar. 29, 2002, entitled “OFFER MANAGER SYSTEM”;

U.S. Provisional Patent Application No. 60/444,250, filed Jan. 31, 2003, entitled “IMPROVED DIGITAL ADVERTISEMENT BOARDS WITH FULL CONNECTIVITY TO POINT-OF-SALE TERMINALS”.

The entirety of each of the above applications is incorporated by reference herein for all purposes.

### CROSS REFERENCE TO RELATED APPLICATIONS

The present application is related to the following commonly-owned, co-pending U.S. patent applications:

U.S. patent application Ser. No. 09/603,677, filed Jun. 26, 2000, entitled “METHOD AND APPARATUS FOR SELECTING A SUPPLEMENTAL PRODUCT TO OFFER FOR SALE DURING A TRANSACTION”; and

U.S. patent application Ser. No. 09/993,228, filed Nov. 14, 2001, entitled “METHOD AND APPARATUS FOR DYNAMIC RULE AND/OR OFFER GENERATION”.

The entirety of each of the above applications is incorporated by reference herein for all purposes.

### BACKGROUND

It is well known that a merchant may make an offer to a customer, and that there are benefits to making an offer to a customer. Many types of offers may be made, different numbers of offers may be made, and offers may be made at various times.

Managing the provision of offers, if attempted, would be extremely difficult and if done inefficiently, could result in reduced advantages or other detriments. Consequently merchants have settled for extremely simplistic systems of providing offers. For example, a merchant may instruct its cashiers who interact with customers at a point-of-sale (POS) terminal to provide a single offer of a particular type (e.g. an offer to purchase a particular additional product) at a particular time (e.g. immediately after the customer has communicated to the cashier all of the products he desires to purchase).

### BRIEF DESCRIPTION OF THE DRAWINGS

FIG. 1 is a schematic diagram of a system according to an embodiment of the present invention.

FIG. 2 is a schematic diagram of an offer server.

FIG. 3 is a table illustrating an exemplary data structure of a transaction volume database.

FIG. 4 is a table illustrating an exemplary data structure of a transaction volume rules database.

FIG. 5 is a table illustrating an exemplary data structure of a transaction slots database.

FIG. 6 is a table illustrating an exemplary data structure of a potential transaction slots database.

FIG. 7 is a table illustrating an exemplary data structure of a potential offers database.

FIG. 8 is a table illustrating an exemplary data structure of a transaction database.

FIG. 9 is a table illustrating an exemplary data structure of a customer offer rules database.

FIG. 10 is a flow chart describing a method according to an embodiment of the present invention.

FIG. 11 is a flow chart describing a method according to an embodiment of the present invention.

FIGS. 12A and 12B are a flow chart describing a method according to an embodiment of the present invention.

FIG. 13 is a flow chart describing a method according to an embodiment of the present invention.

FIG. 14 is a flow chart describing a method according to an embodiment of the present invention.

FIG. 15 is an illustrative example of an offer made on a consumer display during a “begin transaction” transaction slot.

FIG. 16 is an illustrative example of an offer made on a consumer display during an “item ordered” transaction slot.

FIG. 17 is an illustrative example of the offers made on a consumer display during a “transaction subtotal” transaction slot.

FIG. 18 is an illustrative example of the offers made on a consumer display during a “money tendered” transaction slot.

FIG. 19 is an illustrative example of the offers made on a consumer display during a “transaction end” transaction slot.

### DETAILED DESCRIPTION

Applicants have recognized that there are numerous opportunities during a transaction to provide one or more offers to a customer. An opportunity to provide one or more offers at a particular time is also referred to as a “transaction slot”.

Applicants have also recognized that it might not always be appropriate to provide an offer during every opportunity to do so.

Applicants have also recognized that there are many reasons to not provide an offer, including but not limited to the following:

(i) making an offer can affect speed of service to the customer, and there may be drawbacks to an excessive delay in speed of service, such as increasing the time until remaining customers can be served;

(ii) providing too many offers may annoy certain customers; and

(iii) it may be more profitable or otherwise advantageous to provide an offer in a future transaction slot, or to provide a different type of offer based on, e.g., the content of the transaction or the customer.

Applicants have also recognized that it would be advantageous to define various transaction slots in a transaction. A transaction slot is an opportunity to provide an offer. By managing the provision of offers during various transaction slots, the provision of offers may be optimized in accordance with various desired criteria.

In one embodiment, a transaction slot may be defined as a particular period of time. For example, a transaction slot may be the start of or the first ten seconds of a transaction.

In one embodiment, a transaction slot may be defined by one or more “transaction events”, described in further detail below. For example, a transaction slot may be defined as the starting at a particular transaction event and/or ending at another particular transaction event.

In one embodiment, a transaction slot may be defined by whether a particular condition is true or false or continues to be true or false. For example, a transaction slot may be defined to be while a customer is waiting in line to order, while food is being prepared or delivered, while the maximum time for a transaction has not expired, while inventory levels are high, while an local or national advertising campaign is in effect.

Applicants have also recognized that it would be advantageous to define various types of offers, and to manage the provision of such offers during transaction slots.

Applicants have recognized that some benefits of managing offers in accordance with various embodiments of the present invention include improved or optimized revenues, gross margin, profits, speed of service, inventory levels, promotions, labor requirements, and/or customer satisfaction.

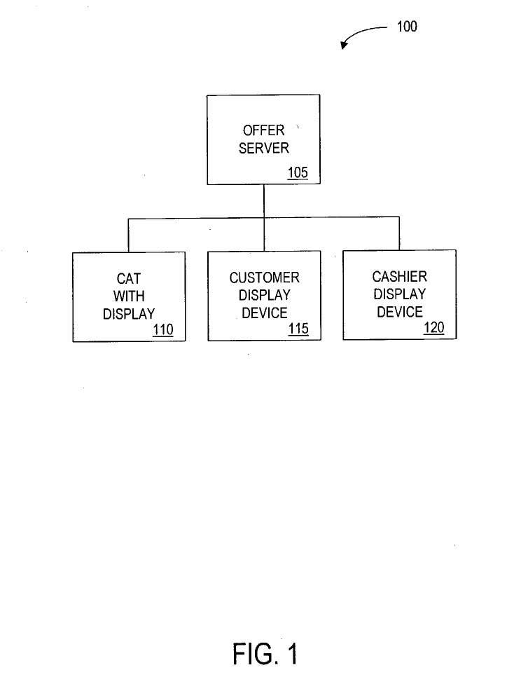

Referring now to FIG. 1, an apparatus 100 according to embodiments of the present invention includes an offer server 105 that is in communication with one or more devices, such as one or more card authorization terminals (CAT) 110 and associated displays, one or more customer display deviccs 115 and one or more cashier display devices 120. As described in further detail herein, the offer server 105 (which may be an existing server that fulfills other in-store POS or back office server duties) is operable to manage and/or optimize the providing of offers in transaction slots. In various embodiments, the offer server 105 (or a peer-to-peer network as an alternative embodiment) can control whether an offer will be made in a given transaction slot, control which offer(s) will be made in a particular transaction slot and/or collect performance data for future use such as optimization (or sharing data among multiple locations).

The offer server 105 may communicate with the devices 110, 115 and 120 directly, via a network such as a Local Area Network (LAN), the Internet or via any other communication technology, as is well known in the art. Each of the devices 110, 115 and 120 may comprise computers, such as those based on the Intel® Pentium® processor, that are adapted to communicate with the offer server 105. Any number of such devices may be in communication with the offer server 105. Further, those of skill in the art will understand that any of the devices 110, 115 and 120 may be omitted, in various embodiments of the present invention.

Communication between the devices 110, 115 and 120 and the offer server 105 may be direct or indirect, such as over the Internet through a Web site maintained by offer server 105 on a remote server or over an on-line data network including commercial on-line service providers, bulletin board systems and the like. In yet other embodiments, the devices may communicate with offer server 105 over radio frequency (RF) signals, cable television signals, satellite communication links and the like.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

The offer server 105 may function as a “Web server” that generates Web pages (documents on the Web that typically include an HTML file and associated graphics and script files) that may be accessed via the Web and allows communication with the offer server 105 in a manner known in the art.

Any or all of the devices 110, 115 and 120 may be, e.g., conventional personal computers, portable types of computers, such as a laptop computer, a palm-top computer, a hand-held computer, or a Personal Digital Assistant (PDA) or they may be specialized devices built for specific purposes such as environmentally hardened displays for use in the drive through or POS terminals with separate or integrated customer LCD's or similar displays.

The card authorization terminal 110 may be any device capable of reading input from credit cards or other cards. The card authorization terminal may be any of several known devices that allow a credit card to be passed (“swiped”) therethrough, thereby permitting information stored on the credit card (typically stored magnetically) to be read. One such card reader is the OMNI 490, sold by VeriFone Inc.

The customer display device 115 may be one or more screens, such as a flat panel monitor or cathode ray tube monitor, that are capable of displaying visual information such as images, text and video. The customer display device 115 may include an audio output such as a speaker, which generates sounds (e.g. synthetic speech, recorded voice or other sounds) as directed by the offer server. The customer display device 115 may include a printer, such as one which prints receipts or coupons, which prints as directed by the offer server. Accordingly, the customer display device 115 can provide offers in displayed, audio and/or printed form. Customer display device is typically associated with (e.g. in communication with, driven by, a peripheral of) a point-of-sale terminal. However, offers may even be provided by, e.g., stations, which are not currently serving customers, such as a customer display device associated with an unmanned POS terminal.

In one embodiment, the customer display device 115 may include a digital menu board, which is operable to display, among other things, product names and corresponding prices.

The customer display device 115 may include a touch screen overlaid on the monitor and capable of receiving manual input from a customer. The customer display device 115 may include other known input devices, such as a microphone for voice input, a keyboard, a stylus, a pen reader, a radio frequency receiver (e.g., for detecting signals from cellular telephones or other transmitting devices) and/or a card reader.

The cashier display device 120 may be, for example, a point-of-sale terminal, such as the IBM 4683 or IBM 4693 manufactured by International Business Machines. As is known in the art, point-of-sale terminals typically include a display capable of displaying, e.g., text messages intended to be read by a cashier operating the terminal.

The apparatus 100 depicted in FIG. 1 is presented by way of example only, and would be typical of an apparatus for use in a retail environment such as a quick service restaurant or grocery store. However, the present invention is not limited to such components and may be used in other environments. For example, the offer server 105 may be a “Web server” of a merchant (e.g. a retail seller) which communicates with one or more computers (or PDAs, cell phones, or similar devices) via Web browser software or similar programs. Similarly, the customer display device may be a personal computer or other device which allows a customer to receive offers and provide responses to offers. The customer display device could also be, e.g., a vending machine, a slot machine or any other device which interacts with customer.

The apparatus 100 may alternatively be configured in a multi-tier architecture, as would be apparent to those of skill in the art. The apparatus 100 may also be configured in a peer-to-peer architecture, as would be apparent to those of skill in the art.

The offer server 105 may be operable to generate and/or serve Web pages (documents on the World Wide Web that typically include a Hypertext Markup Language file and associated graphics and script files) that may be accessed via the World Wide Web and allow purchases from the merchant to be made in a manner well known in the art. A Web site typically consists of several such Web pages and associated databases served by one or more HTTP (Hypertext Transfer Protocol) servers (e.g. the offer server 105) on the World Wide Web. Alternatively, the offer server 105 may be a computer involved in operating a physical store. Such a computer, for example a point of sale (POS) server, could perform such tasks as inventory management and transaction processing for the store.

Similarly, the offer server 105 may be in communication with customers via telephones and an Interactive Voice Response Unit. Thus, a customer may hear audio output from the offer server 105 via a telephone (e.g. while on hold with the merchant or a different merchant), and communicate with the offer server 105 via voice or by pressing buttons on the telephone.

As described in detail herein, a transaction event is a particular point during a transaction. Different transactions may include different numbers and types of transaction events. Some examples of transaction events include, but are not limited to, the following:

receiving an indication of a payment type from a customer

receiving an instruction from an external system to increase or decrease the likelihood of or to make a particular offer

greeting a customer

prompting a customer to select a product

receiving an indication of a product selected for purchase by a customer

determining a cost of a product selected for purchase by a customer

displaying an indication of a product selected for purchase by a customer

determining a total cost to be paid by a customer

indicating a total cost to a customer

identifying a customer (and possibly his purchasing history)

receiving a payment from a customer

providing a product to a customer

determining an amount of time available to make one or more offers

determining inventory available for an offer

determining a relevant item to offer a customer based upon:

their order contents

time of day or day of week

order location or destination

current sales volume

current speed of service measurements

cashier accepting order

profit targets

current marketing campaigns

items indicated as not available by senior or in-store management or crew

items flagged as items to offer as frequently as possible excluding items flagged not to be offered when certain items are ordered by the customer (a.k.a. “exclusion sets”)

amount of change due

customers' order contents as compared with their buying history

number of persons in the party (as determined via several methods, e.g., number of drinks ordered, number of entrée items ordered, cashier or customer entry of the number in their party)

likelihood of customer acceptance of the offer

overall probable impact on speed of service

current or forecasted number of customers in line

current or forecasted weather, or

any additional rules or business logic established by senior or in-store management and crew or as developed via an “adaptive model” using genetic algorithms or other widely known statistical methodologies that are designed to optimize results

According to various embodiments, the offer server 105 is operable to determine the occurrence of transaction events, and thereby identify transaction slots that are defined by such transaction events. The offer server 105 may determine the occurrence of transaction events in many ways. For example, the offer server 105 may receive signals that indicate one or more particular transaction events. The offer server 105 can receive a signal from a POS terminal indicating that a particular transaction event has occurred, is about to occur or will occur. The POS terminal is capable of determining many transaction events that are indicated by actions that conventionally occur, such as certain buttons being actuated by a cashier, certain POS terminal functions being performed, or certain messages being output by the POS terminal.

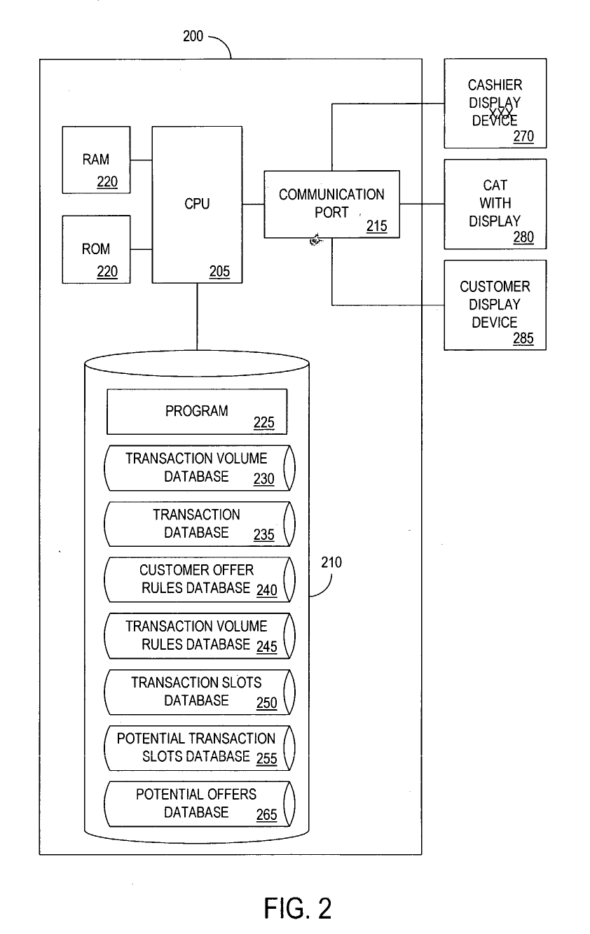

The offer server 105 may also or alternatively include one or more signal detectors that detect such signals and transmit an indication of the detected signals to the processor 205 (FIG. 2). For example, the offer server 105 may receive a signal from a sensor in a drive-through of a quick service restaurant, from a cellular telephone, credit card, customer loyalty card or device, or from a license plate image scanner.

Transaction events may be used to define a transaction slot in various ways. Examples of transaction slots include, but are not limited to:

as the customer approaches a restaurant (in which the customer can be identified via his telephone, EZpass device, or license plate);

when a customer enters a restaurant;

when a customer gets in line to place an order;

when a customer registers for a table at a restaurant

when a customer is greeted (e.g., by an employee or at a kiosk);

when a customer is prompted to place an order (e.g., by an employee or a kiosk);

when a customer identifies himself via, e.g., a frequent shopper number, a frequent shopper card, a payment identifier such as a credit card number, a biometric input such as a fingerprint scan, any unique identifier such as name, loyalty program ID, driver's license number, or license plate number;

when a cashier presses a button on a POS terminal (such as dine in or take out)

when a customer presses a button on a kiosk or telephone

after a customer selects a first product to purchase, but before a customer selects a second product to purchase (e.g., after a customer indicates that he wants a hamburger, but before he orders a drink);

while a customer is selecting products to purchase (e.g., “I want a hamburger with onions, pickles, ketchup, no mustard, lettuce . . . ”);

after a customer finishes selecting products to purchase, but before a total price is calculated;

after a subtotal price is calculated, before the total price (e.g., which further included tax and gratuity) is calculated;

after a transaction total is calculated;

when a customer is prompted to indicate what type of payment he intends to provide;

after a customer indicates what type of payment he intends to provide (e.g., credit card, debit card, cash, EZPass or other radio frequency payment system);

when a customer is prompted to provide payment;

when a customer provides payment to purchase at least one product;

after a customer provides payment, but before any change due is provided to the customer;

after a customer provides payment, before a receipt is provided to the customer;

while a payment provided by a customer is being processed (e.g., while waiting for payment authorization from a credit card clearinghouse system);

while an aspect of an order is being calculated by a computer process (e.g., in an embodiment in which significant calculations or communications must be performed as part of an order, or in which point of sale terminals have limited computing power or communications bandwidth);

after a customer provides payment for a product, before the product is provided to a customer;

after a product is provided to a customer, before the customer provides payment for the product;

while a customer is waiting for a food item to be prepared;

when a product is provided to a customer (e.g., by an employee of the merchant);

while a customer is consuming a meal, but before the customer leaves a restaurant;

after a customer purchases a product, but before the customer leaves a store;

when a customer identifies himself to a website (e.g., by logging on and providing a password);

when a customer operates an electronic device (e.g., a kiosk in a department store);

when a third party requests to make an offer to a customer using “events” or “alerts”, such as a software program making a request (with or without requirement for a fee payment);

when a customer is at the counter;

when a customer arrives at the first drive through ordering station, at a pickup window or cashier window;

FIG. 2 illustrates an embodiment 200 of the offer server 105 of FIG. 1. The offer server may be implemented as a system controller, a dedicated hardware circuit, an appropriately programmed general purpose computer such as an Intel based PC, a server computer such as a Sun Fire B100s Blade Server manufactured by Sun Microsystems Inc or a “Precision Workstation” or “Poweredge 350” manufactured by Dell Computer Corporation, or any other equivalent electronic, mechanical or electromechanical device suited for the volume of transactions and the performance levels desired.

The offer server comprises a processor 205, such as one or more Intel® Pentium® processors. The processor 205 is coupled to a communication port 215 through which the processor 205 communicates with other devices. The processor 205 is also in communication with a data storage device 210. The data storage device 210 comprises an appropriate combination of magnetic, optical and/or semiconductor memory, and may include, for example, Random Access Memory (RAM), Read-Only Memory (ROM), a compact disc and/or a hard disk. The processor 205 and the storage device 210 may each be, for example: (i) located entirely within a single computer or other computing device; or (ii) connected to each other by a remote communication medium, such as a serial port cable, telephone line or radio frequency transceiver. In one embodiment, the offer server may comprise one or more computers that are connected to a remote server computer for maintaining databases.

The data storage device 210 stores a program 225 for controlling the processor 205. The processor 205 performs instructions of the program 225, and thereby operates in accordance with the present invention, and particularly in accordance with the methods described in detail herein. The program 225 may be stored in a compressed, uncompiled and/or encrypted format. The program 225 furthermore includes program elements that may be necessary, such as an operating system, a database management system and “device drivers” for allowing the processor 205 to interface with computer peripheral devices. Appropriate program elements are known to those skilled in the art, and need not be described in detail herein.

According to an embodiment of the present invention, the instructions of the program 225 may be read into a main memory from another computer-readable medium, such from a ROM 222 to a RAM 220. Execution of sequences of the instructions in program 225 causes processor 205 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

The storage device 210 also stores (i) a transaction volume database 230, (ii) a transaction database 235, (iii) a customer offer rules database 240, (iv) a transaction volume rules database 245, (v) a transaction slots database 250, (vi) a potential transaction slots database 255, (vii) a potential offers database 265. The databases are described in detail below and depicted with exemplary entries in the accompanying figures. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

Various functionality of the offer server described herein may alternatively be performed by the CAT 110, the customer display device 115, the cashier display device 120 and/or a remote server or system. For example, an appropriately programmed point-of-sale terminal may perform various functions described herein as being performed by the offer server.

Transaction Volume Database

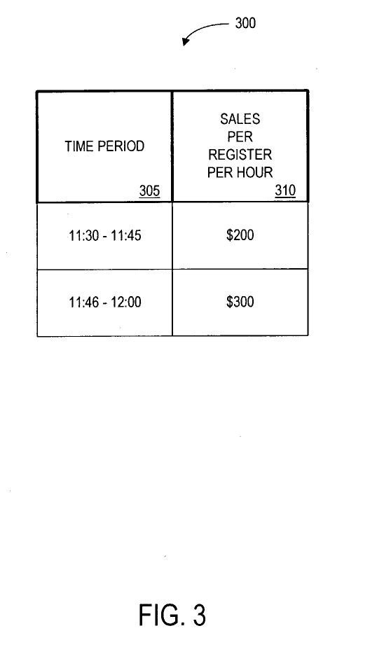

FIG. 3 is a tabular representation 300 of the transaction volume database. The tabular representation of the transaction volume database includes a number of example records or entries, each defining a transaction volume during a time period. Those skilled in the art will understand that the transaction volume database may include any number of entries. The tabular representation 300 of transaction volume database also defines fields for each of the entries or records. The fields specify: (i) a time period 305 and (ii) the transaction volume, represented in terms of sales per register per hour or items per hour per register. Many other representations of transaction volume may be used as desired.

Transaction Volume Rules Database

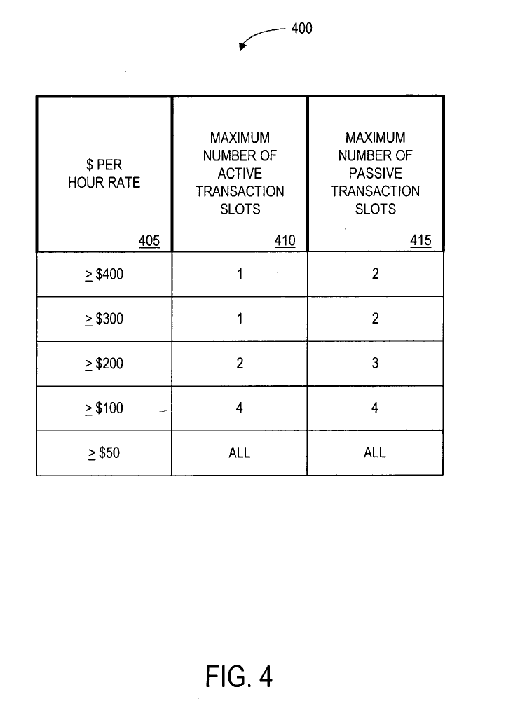

FIG. 4 is a tabular representation 400 of the transaction volume rules database. The tabular representation of the transaction volume rules database includes a number of example records or entries each defining a rule applicable at a particular transaction volume. Those skilled in the art will understand that the transaction volume rules database may include any number of entries. The tabular representation of the transaction volume rules database also defines fields for each of the entries or records. The fields specify: (i) a transaction volume 405, which is represented as items or dollars of sales per hour; (ii) a maximum number 410 of active transaction slots to have in a transaction; and (iii) a maximum number 415 of passive transaction slots to have in a transaction. Thus, in the depicted example, particular transaction volumes are associated with (i) a maximum number of transaction slots during which active offers may be provided, and (ii) a maximum number of transaction slots during which passive offers may be provided.

Many other representations of transaction volume besides sales per hour may be used as desired. Similarly, many other representations of rules associated to particular transaction volume may be used as desired. For example, the maximum number of active transaction slots to have in a transaction may be periodically calculated as a factor of the current transaction volume (e.g. one transaction slot for every $100 sales per hour).

Transaction Slots Database

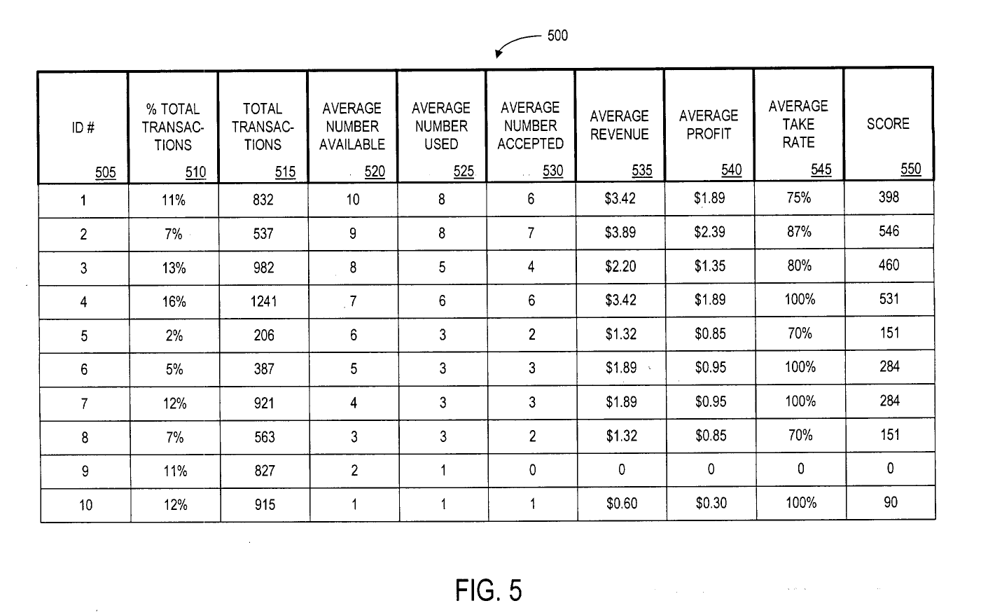

FIG. 5 is a tabular representation 500 of the transaction slots database. The tabular representation of the transaction slots database includes a number of example records or entries each defining historical data and/or other data regarding a particular transaction slot. Those skilled in the art will understand that the transaction slots database may include any number of entries. The tabular representation of the transaction slots database also defines fields for each of the entries or records. The fields specify: (i) a transaction slot identifier 505, which uniquely identifies the particular transaction slot; (ii) the percent 510 of the total transactions in which an offer was provided during the particular transaction slot; (iii) the number 515 of transactions in which an offer was provided during the particular transaction slot; (iv) the average number 520 of offers which may be provided during the particular transaction slot; (v) the average or actual number 525 of such offers which are provided; (vi) the average or actual number 530 of such offers which are accepted; (vii) the average or actual revenue 535 from providing such offers; (viii) the average or actual profit 540 from providing such offers; (ix) the average or actual acceptance rate (also called “take rate”) 545 of offers provided during the particular transaction slot; and (x) a score 550 of the particular transaction slot, which generally indicates a success rate of providing offers during the transaction slot. The score of a transaction slot may be calculated in many ways as desired, such as by evaluating the profitability, acceptance rate and/or sales increase due to providing offers in the transaction slot. The score could also be manually entered. The percent of transactions in which a transaction slot is going to be used can also be manually set.

Potential Transaction Slots Database

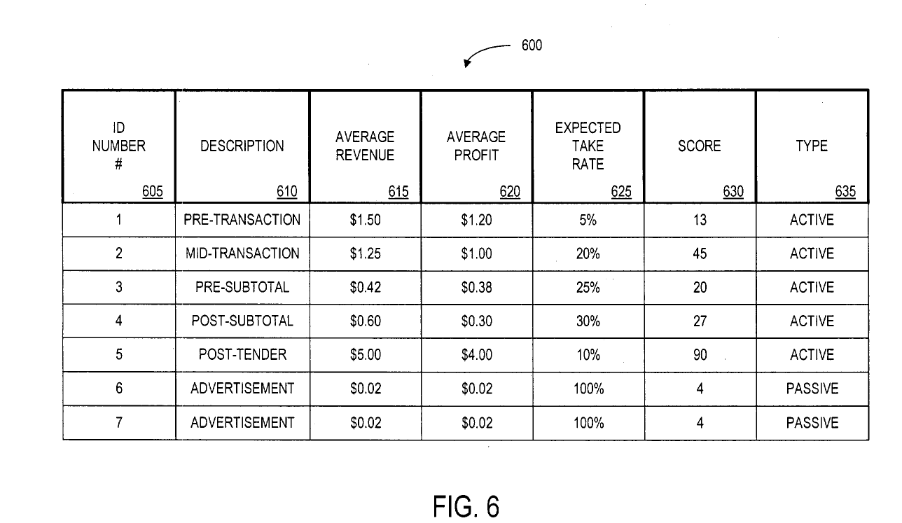

FIG. 6 is a tabular representation 600 of the potential transaction slots database. The tabular representation of the potential transaction slots database includes a number of example records or entries, each defining a potential transaction slot available during a transaction, and during which an offer may be provided. Those skilled in the art will understand that the potential transaction slots database may include any number of entries. The tabular representation of potential transaction slots database also defines fields for each of the entries or records. The fields specify: (i) a transaction slot identifier 605, which uniquely identifies the particular transaction slot; (ii) a description 610 of the particular transaction slot; (iii) an average revenue 615 for the type of offer provided during the particular transaction slot; (iv) an average profit 620 for the type of offer provided during the particular transaction slot; (v) an expected take rate (acceptance rate) 625 of the type of offer provided during the particular transaction slot; (vi) a score 630 of the particular transaction slot, which generally indicates a success rate of providing the type of offer provided during the transaction slot; and (vii) the type 635 of offer which may be provided during the particular transaction slot. The score 630 may be calculated in many ways as desired, such as by evaluating individually or in any combination the profitability, acceptance rate and/or sales increase due to providing offers in the transaction slot. The score could be manually set.

The type of offer can, in one embodiment, be either “active” or “passive”. In such an embodiment, an active offer permits or requires a response from the customer. For example, an active offer may require a response from the customer, such as “Which item do you want: an apple pie or a large French fries?” An active offer may similarly permit, but not require, a response. For example, a display with a touch screen may include a graphical button that, if pressed by the customer, adds a particular product (good and/or service) to the customer's order.

A passive offer does not require a response from the customer but may attempt to solicit one. For example, a passive offer may be an advertisement, which is displayed to the customer, such as an advertisement informing the customer of a particular product.

In one embodiment, a description of a transaction slot (not depicted in FIG. 6) can include “Events Driven”. In such a transaction slot, another software application or system can set the transaction type as desired. Thus, partial control can be delegated to another system, possibly one operated by another entity separate from the entity that operates the offer server. This control may be provided via an application program interface (API) or via an XML interface or other methods well known in the prior art to permit two independent programs to communicate uni or bi-directionally or to completely or partially direct the control of another application.

In one embodiment, a description of a transaction slot (not depicted in FIG. 6) can include

“Promotions”. In such a transaction slot, any in-store promotions or third party promotions in effect could be provided to the customer, typically, but not exclusively, during the “pre-transaction” slot.

Potential Offers Database

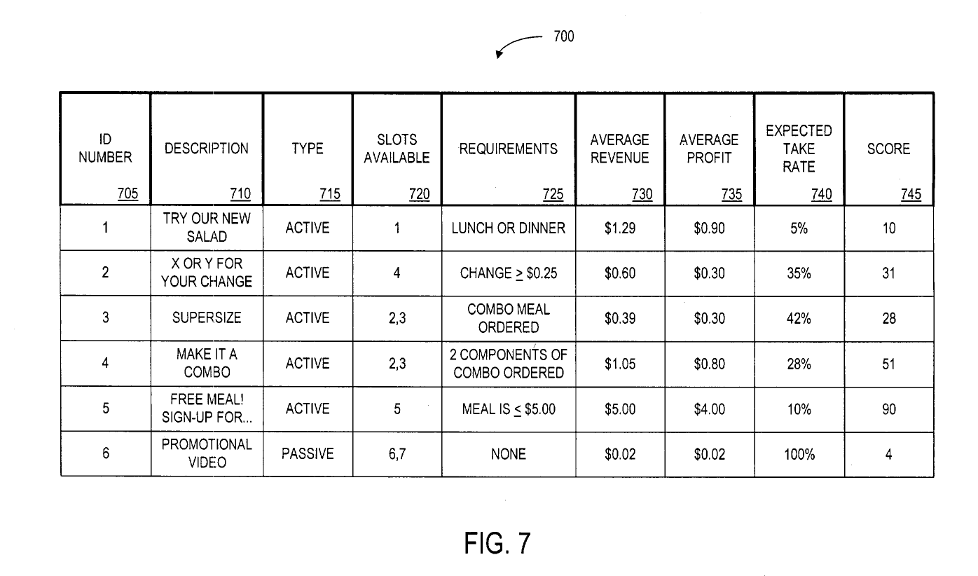

FIG. 7 is a tabular representation 700 of the potential offers database. The tabular representation of the potential offers database includes a number of example records or entries, each defining a potential offer which may be provided. Those skilled in the art will understand that the potential offers database may include any number of entries. The tabular representation of potential offers database also defines fields for each of the entries or records. The fields specify: (i) an offer identifier 705, which uniquely identifies the particular offer; (ii) a description 710 of the particular offer; (iii) the type 715 of the particular offer; (iv) the number 720 of transaction slots during which the particular offer may be provided; (v) the requirements 725, if any, which must be met for the offer to be provided; (vi) the average revenue 730 from providing the particular offer; (vii) the average profit 735 from providing the particular offer; (viii) the expected take rate (acceptance rate) 740 of the particular offer; and (ix) a score 745 of the particular offer, which generally indicates a success rate of providing the particular offer.

Many types of requirements may be imposed in order for the offer to be provided. For example, certain products must be ordered (or, alternatively, not ordered), certain products must be available, a certain change amount or range must be due, the transaction total must be within a particular range, the transaction must occur during a particular time of day or day of the week, and/or the customer must be identified or not identified.

The score 745 may be based on historical data, rules, and/or information stored in database tables. The score 745 may be calculated in many ways as desired, such as by evaluating the profitability, acceptance rate, customer's visit frequency or return rate, and/or revenue increase due to providing the particular offer. The score 745 may additionally or alternatively be based on any or all of the following:

the activity rate (e.g. current or forecasted transactions per minute, sales per hour, number of customers in line) of the merchant, or of the particular POS terminal;

the average time required to complete a transaction or (provide and if necessary receive an acceptance of) the offer;

the labor required;

the likelihood that the customer or cashier is “gaming” the system or the offer would be “dilutive” by cannibalizing sales that would have been made anyway;

the discount included in the offer (if any);

how customers have in general responded to previously provided offers;

how the particular customer has responded to previously provided offers;

the time of day or part of the day during which the offer is provided;

the current or forecasted weather;

whether a product being or to be offered is available;

whether a third party (e.g. supplier, manufacturer, another merchant) is willing to subsidize the offer by paying for the opportunity to make an offer;

whether and how the acceptance or rejection of the offer will affect other offers that might be provided later in the transaction (e.g., likely accept rate and profitability of subsequent offers);

the fit with a particular promotional or marketing campaign;

the fit with other offers;

the fit with the businesses financial and operating goals; and

a preference set by, e.g., a store manager.

Transaction Database

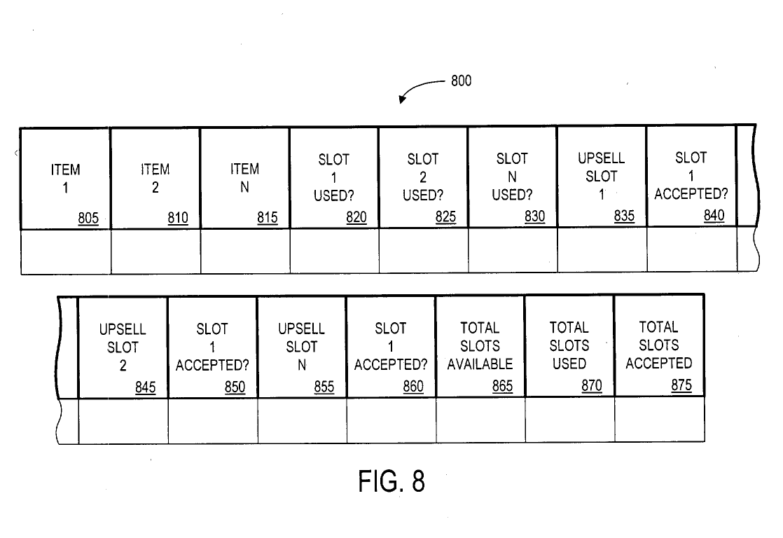

FIG. 8 is a tabular representation 800 of the transaction database. The tabular representation of the transaction database includes a number of example records or entries, each defining a previous transaction in which a customer interacted to, e.g., purchase a product. Those skilled in the art will understand that the transaction database may include any number of entries. The tabular representation of transaction database also defines fields for each of the entries or records. The fields specify: (i) items purchased 805, 810 and 815, any number of which may be purchased though three are depicted; (ii) whether particular transaction slots were “used” 820, 825 and 830 (i.e. whether offers were provided during those transaction slots), any number of which may be used though three are depicted; (iii) which offers, if any, were provided in particular transaction slots 835, 845, 855, any number of transaction slots may include offers though three are depicted; (iv) whether the offers provided in the particular transaction slots were accepted 840, 850, 860, any number of transaction slots may include offers though three are depicted; (v) the total number of transaction slots 865 which were available for providing offers; (vi) the total number of transaction slots 870 during which one or more offers were provided; and (vii) the total number of transaction slots 875 during which an offer was provided and that offer was accepted. Other fields (not depicted in FIG. 8) may specify, e.g., a unique transaction ID number, the order total, the payment method or type, and/or a timestamp of the transaction.

Customer Offer Rules Database

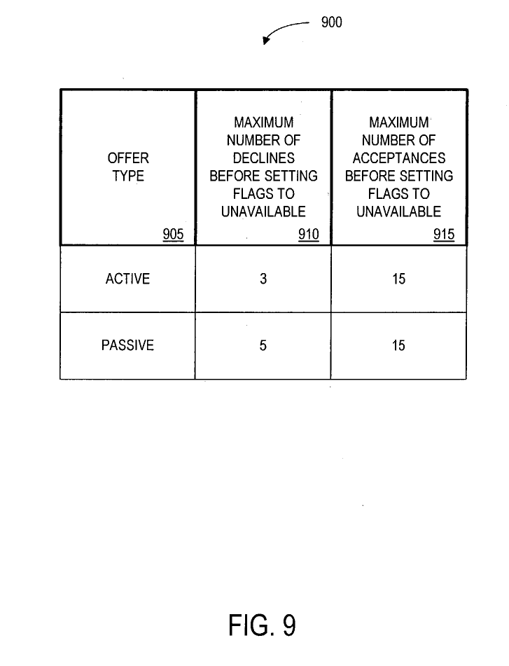

FIG. 9 is a tabular representation 900 of the customer offer rules database. The tabular representation of the customer offer rules database includes a number of example records or entries, each defining an offer and rules which apply to the provision of those offers. Those skilled in the art will understand that the customer offer rules database may include any number of entries. The tabular representation of customer offer rules database also defines fields for each of the entries or records. The fields specify: (i) an offer type 905, (ii) a maximum number of declines 910 (i.e. offer not accepted by the customer) before the type of offer is marked as unavailable for providing again during the same transaction; and (iii) a maximum number of acceptances 915 by the customer before the type of offer is marked as unavailable for providing again during the same transaction.

Although the example depicted in FIG. 9 categorizes offers by offer type, offers may be categorized in many other ways, or specified individually as desired. Similarly, although the example depicted in FIG. 9 describes a particular type of rule (i.e. maximum numbers of declines and acceptances before prohibiting the provision of the particular offer), many other rules may be used to define the provision of offers based on customer behavior, actions or other customer-related data. For example, instead of making a type of offer unavailable, the type of offer could merely be provided less frequently.

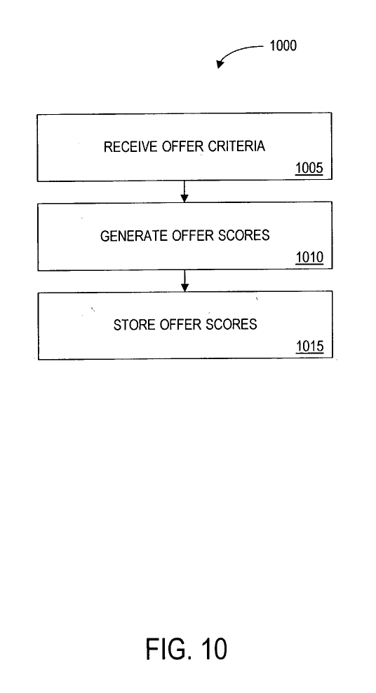

Referring to FIG. 10, a flow chart 1000 represents an embodiment of the present invention that may be performed by the offer server 105 in determining optimal offers to make. Such an embodiment can be advantageous by allowing several potential offers to be evaluated according to widely varying preferences, such as accept rate probability, speed of service and profit. The particular arrangement of elements in the flow chart of FIG. 10, as well as the other flow charts discussed herein, is not meant to imply a fixed order to the steps; embodiments of the present invention can be practiced in any order that is practicable.

At step 1005, the offer server receives offer criteria. As described herein, various offer criteria may be used, as desired. Using such criteria, a plurality of potential offers are scored, generating an offer score for each potential offer (step 1010). The offer scores are stored (step 1015) in a manner known in the art (e.g. in volatile or permanent memory), and such scores may be used in a number of manners as described herein.

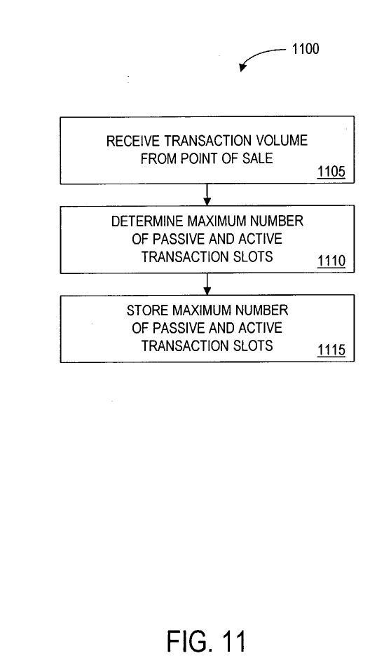

Referring to FIG. 11, a flow chart 1100 represents an embodiment of the present invention that may be performed by the offer server 105 in determining the maximum number of offers to make based on various criteria. Such an embodiment can be advantageous by limiting the number of offers, and thereby constraining the total time of a transaction.

At step 1105, the offer server may receive transaction volume from one or more point of sale terminals. As described herein, transaction volume may be measured in many ways, such as dollars of sales per unit of time or transactions per unit of time. Based on the transaction volume, a maximum number of passive transaction slots and a maximum number of active transaction slots are determined (step 1110). In other words, the offer server determines a maximum number of transaction slots during which active offers may be provided, and a maximum number of transaction slots during which passive offers may be provided.

For example, in one embodiment active offers and passive offers may have corresponding estimated time delays. Based on such time delays, and the transaction volume, the maximum allowable time delays may be established by establishing the maximum number of transaction slots during which active and passive offers may be provided.

Various criteria can be used to determine the maximum number of passive transaction slots and a maximum number of active transaction slots, including:

the merchant with which the transaction occurs (e.g. different merchants or types of merchants may include different transaction slots);

the location of the transaction (e.g. at the drive through order station, or drive through pick up or cashier windows, kiosk, or at the counter of a quick service restaurant);

the time of day or part of day during which the transaction takes place;

the average transaction total;

the current order contents;

the previous acceptance or rejection of an offer (e.g., if a customer continuously rejects offers, the system may only present passive offers, so as not to offend the customer and/or adversely affect speed of service) the current number of items to purchase in the transaction;

the order contents compared with the customer's ‘typical’ order contents;

the weather;

the amount of change due;

the current average speed of service for each transaction;

the customer's likelihood of accepting a given offer based upon their acceptance history;

the number of cashiers or other labor availability;

product availability or inventory amounts;

other constraints or business logic/rules established by senior or in-store management and crew;

current promotional campaigns.

At step 1115, the maximum number of passive and active transaction slots is stored for use as described herein.

In other embodiments, the offer server can use a completely random method to test the number of transaction slots and types of offers (e.g., in all combinations including varying discount levels and full-price offers) to determine and evaluate probability models on a store-wide, transaction, cashier, time of day, day of week, weather, and customer basis. Accordingly, embodiments of the present invention flexibly make use of as much information as may be available, yet no particular information is required.

As various tests are performed, information from the test results (e.g., performance) may be exploited to increase performance. Thus, the offer server may continually exploit what it knows and periodically explores additional strategies in order to uncover new workable combinations and successful offers.

In other embodiments, other criteria besides transaction volume (e.g., consumer acceptance) can be used to determine the maximum number of offers. In general actual and predicted performance of offers may be used to determine the maximum number of offers and/or when to provide offers.

For example, it may be more advantageous to provide an offer near the end of a transaction. Otherwise, a customer may become annoyed or on the offers before the offer that is either the most profitable or most likely to be accepted is presented. The offer sever is capable of “testing” different combinations of offers (e.g., passive and active) and various offer types (e.g., upgrades, additional items, coupons, take-away items, etc.) and/or non-offers (i.e., wait to make an offer) to determine which offer sequences, types and combinations yield the best performance for a particular store, time of day, day of week, weather conditions, order contents, change due amounts, speed of service, profitability, customer buying patterns or preferences.

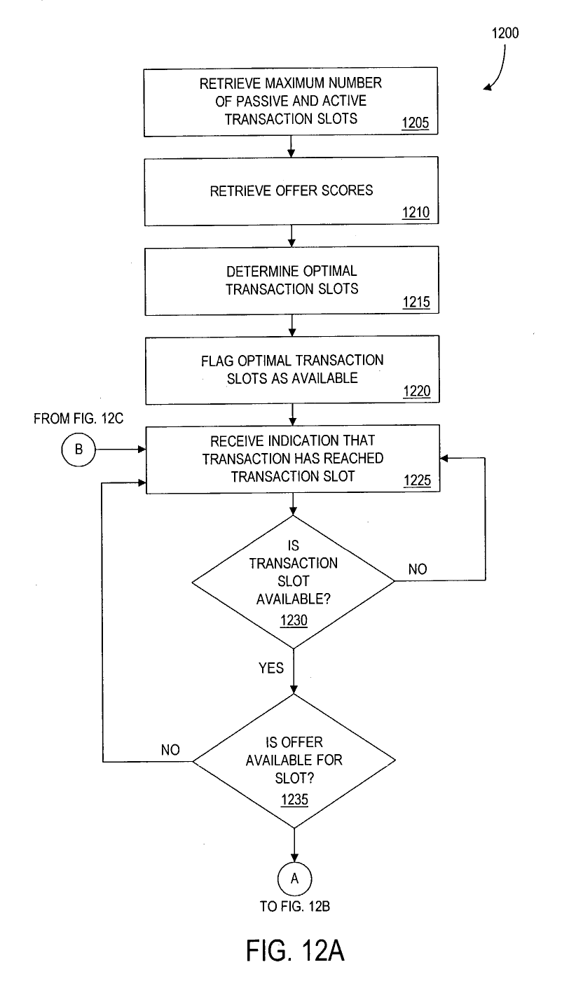

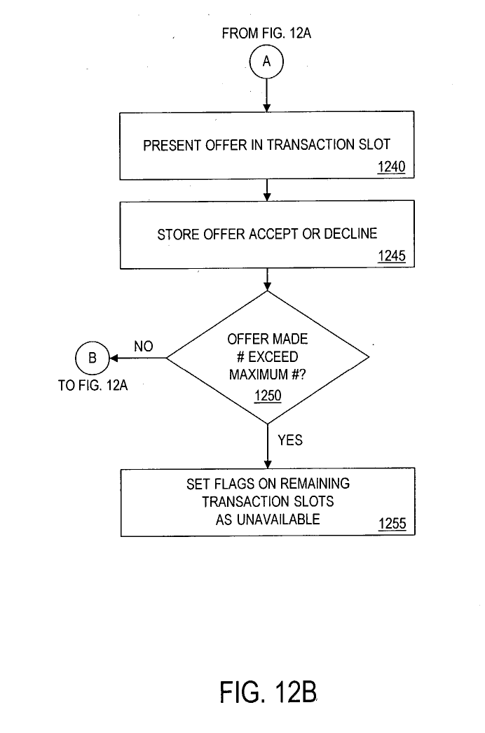

Referring to FIGS. 12A and 12B, a flow chart 1200 represents an embodiment of the present invention that may be performed by the offer server 105 in making optimal offers based on available transaction slots, current transaction information and/or historical results data. In the depicted embodiment, a limit may be calculated or imposed on the number of offers that may be provided. In other embodiments, additional or alternate criteria may be used in making offers. The method illustrated by 1200 may be used in conjunction with the maximum numbers described with respect to FIG. 11.

At step 1205, the maximum numbers (if any) of passive transaction slots and active transaction slots is retrieved from storage. At step 1210, offer scores (which may have been previously stored or concurrently generated) are retrieved. Based on the offer scores and the maximum numbers of passive and active transaction slots, the offer server 105 determines the optimal transaction slots during which offers should be provided (step 1215). These transaction slots are flagged as being available (step 1220), so that offers may be provided during these transaction slots. In other embodiments, however, transaction slots need not be flagged as available, and other means for determining when to provide offers will be readily apparent.

The offer server receives an indication that the transaction has reached a particular transaction slot (step 1225). If it is determined that the transaction slot is available (step 1230) and if there is one or more offers available for the transaction slot (step 1235) then the offer server predicts whether the currently available offers would likely generate either a higher acceptance rate and/or profits than subsequent potential offers or if the current offers would likely reduce the likelihood of subsequent offers, if the currently available offers would likely generate the highest accept rate or profits and/or if they are not likely to adversely affect subsequent offers. Then the available offer(s) are provided during the transaction slot (step 1240) and the results of the offer (e.g., whether the customer accepted or declined the offer) are stored (step 1245) and the outcome of subsequent offers are likewise stored. At step 1250, the offer server determines whether the provided offer results in either the maximum numbers of passive offers or the maximum number of active offers has been equaled or exceeded and/or accepted. If so, then no more offers are permitted and the remaining transaction slots, if any, are made unavailable for additional offers (step 1255). If no such maximums are met (step 1250), or if the transaction slot is unavailable (step 1230), or if there is no offer available for the transaction slot (step 1235), then the transaction continues being monitored for additional transaction slots (step 1225).

In various embodiments, a plurality of offers, passive and/or active, can be provided during the same transaction slot, and the same offer may be provided more than once during the same transaction. Similarly, variations of the same offer may be provided. For example, if a customer rejects an offer to add an item to their order immediately, the offer server may provide an offer for the same (or different) item(s) for later purchase via a coupon or other deferred method. Criteria for repeating an offer include: the probability of acceptance of the offer and whether the offer has been accepted already (or, in the case where the consumer's buying habits and preferences are known, accepted or rejected in the recent past). Further, the size, location, dimensions and other appearance parameters or the discount value (if any) or the perceived value of an offer that is displayed or printed can also be varied according to the performance of the offer, as described herein.

In one embodiment, the offer server may determine if a customer is not likely to accept subsequent active offers. If so, the offer server may cease making any offers, may switch to passive only offers, or may increase or decrease the discount amount. A decrease in the discount might train the customer to take the first offer, while an increase in the discount might entice the customer to take the offer.

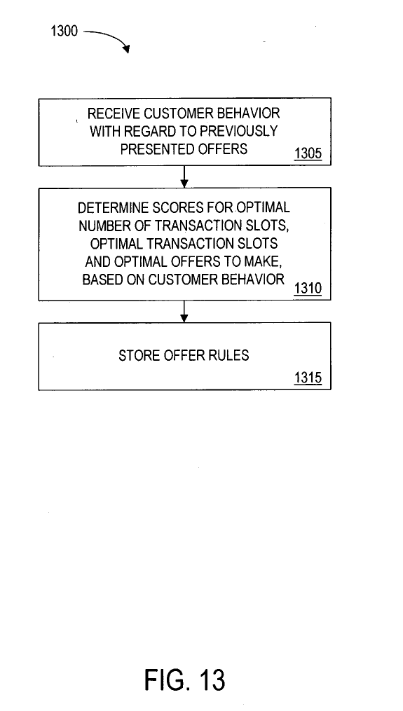

Referring to FIG. 13, a flow chart 1300 represents an embodiment of the present invention that may be performed by the offer server 105 in using data about customer behavior to manage offers. Such an embodiment can be advantageous in that offers can be tailored to be more likely to be accepted by the particular customer. At step 1305, the offer server receives data indicating customer behavior, such as data regarding how the customer reacted when offers were previously provided. For example, such data may include the offers and/or associated transaction slots in which the customer accepted or declined offers. The offer server may use such information to try new offers or offer types (e.g., coupons) and/or increase the discount associated with the offer or offer type. The offer server may also solicit third party subsidies to offset a portion or all of the cost of such discounts. The system may attempt to provide discounted or free offers to try new items or visit the location during a different day part.

At step 1310, the offer server determines, based on the data indicating customer behavior, scores for an optimal number of transaction slots during which to provide offers, a set of particular transaction slots deemed optimal for offers to be provided during, and a set of optimal offers to make. At step 1315, the offer server stores such scores, and may also generate therefrom offer rules which correspond to the scores.

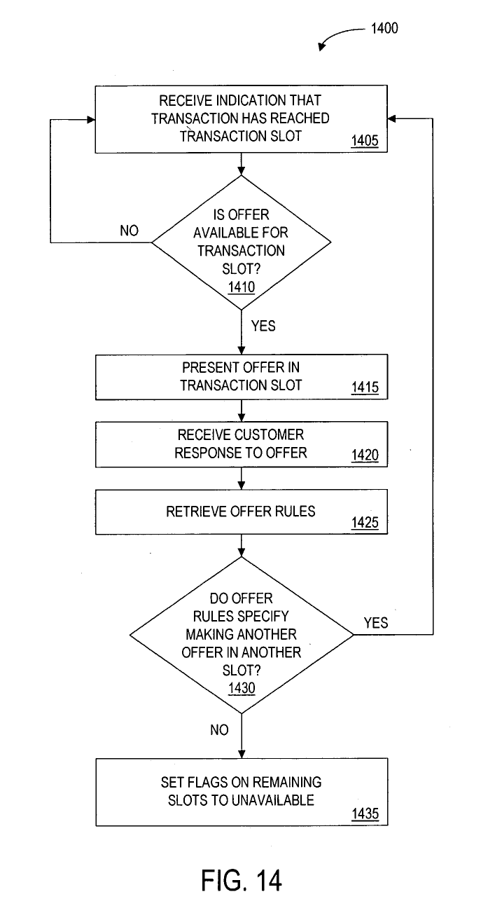

Referring to FIG. 14, a flow chart 1400 represents an embodiment of the present invention that may be performed by the offer server 105 in making optimal offers based on customer behavior. The method illustrated by 1400 may be used in conjunction with the scores and/or rules described with respect to FIG. 13. The illustrated method may be performed in advance for all potential transaction slots or during a transaction as the transaction slots occur.

At step 1405, the offer server receives an indication that the transaction has reached a particular transaction slot, and it is determined if an offer is available to provide during the transaction slot (step 1410). If not, then the transaction continues being monitored for additional transaction slots (step 1405). If an offer is available to provide during the transaction slot, and such an offer is not determined to be detrimental to subsequent transaction slots or the overall transaction, then an offer is provided during the transaction slot (step 1415). If the offer permits a response, then the customer's response is received (step 1420). The offer rules are retrieved (step 1425), and if the offer rules specify making another offer during another transaction slot (step 1430), then the transaction continues being monitored for additional transaction slots (step 1405). Otherwise, the remaining transaction slots, if any, are made unavailable for additional offers (step 1435).

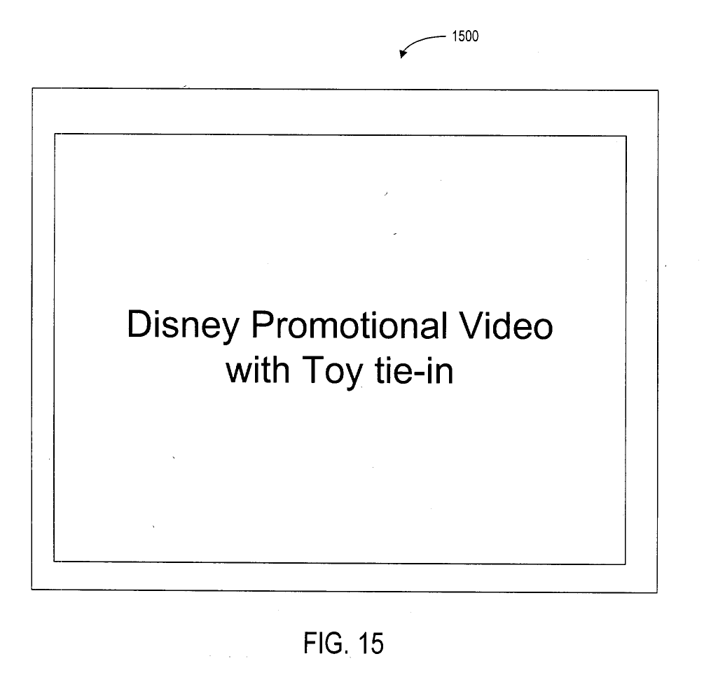

FIG. 15 depicts an example 1500 of an offer that is provided on a customer display device during a “begin transaction” transaction slot. Such offers may comprise, e.g., video, text, images and/or audio. Presenting a passive offer at the beginning of a transaction can be advantageous in that often at the beginning of the transaction there has not yet been received from the customer sufficient information to provide an optimal offer. Further, at this point in the transaction it may be prudent not to distract the customer by permitting him to respond to an offer.

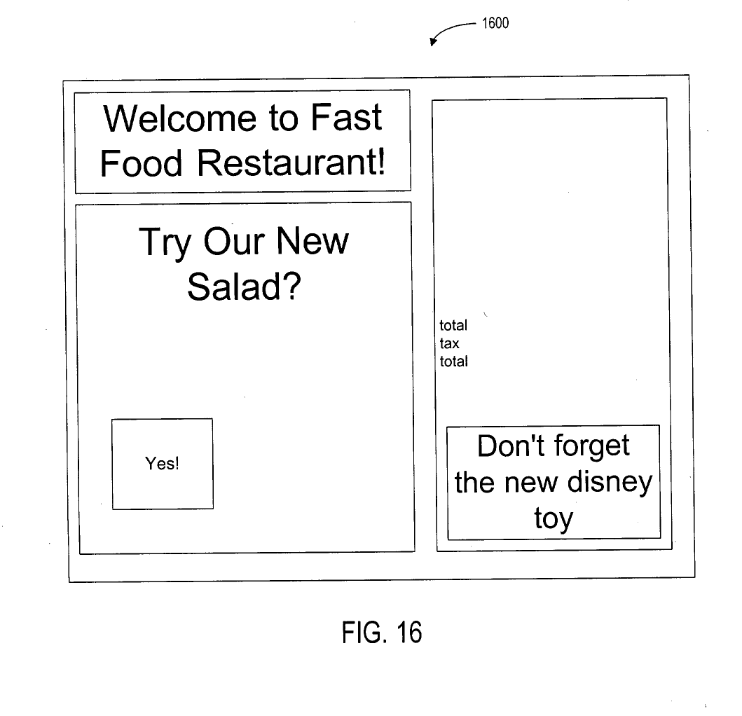

FIG. 16 depicts an example 1600 of offers that are provided on a customer display device during an “item ordered” transaction slot. One offer (“Try Our New Salad?”) is an active offer which permits the customer to respond (e.g., by pressing the “Yes!” button on the display). Another offer is a passive offer similar or identical to the offer of FIG. 15.

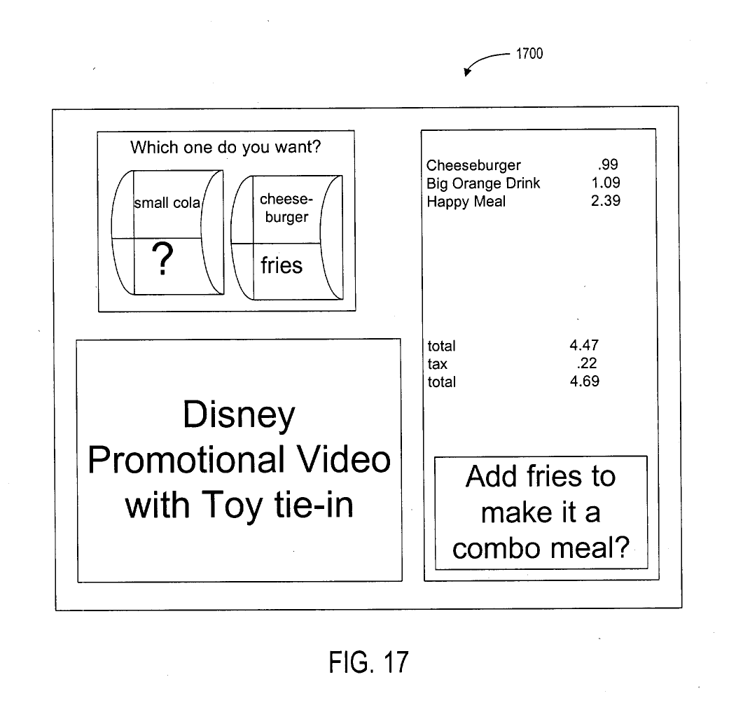

FIG. 17 depicts an example 1700 of offers that are provided on a customer display device during a “transaction total” transaction slot. One offer (“Which one do you want?. . . ”) is an active offer which permits the customer to respond (e.g., by pressing one of the buttons on the display which represent a product to purchase or to decline the offer). Another offer is a passive offer similar or identical to the offer of FIG. 15. The third offer “Add fries to make it a combination meal?” is a passive offer which may prompt the customer to request that fries be added to his order.

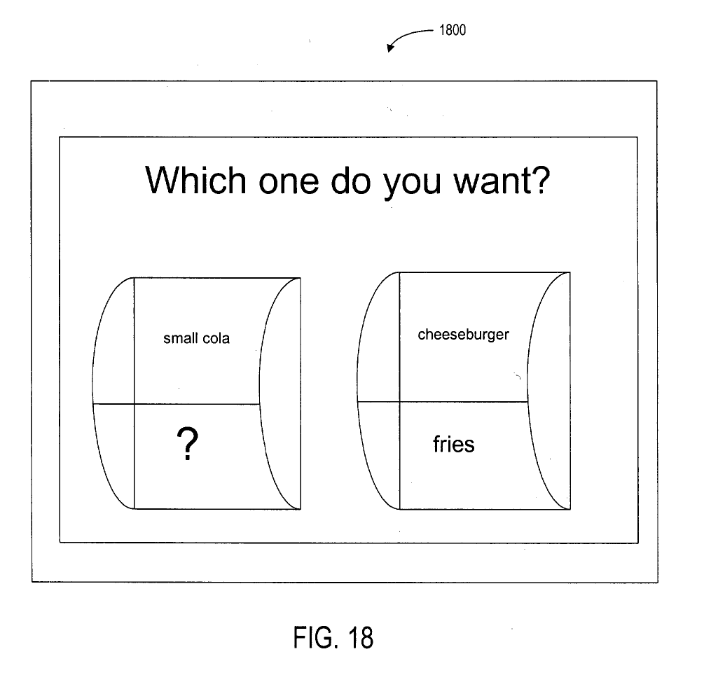

FIG. 18 depicts an example 1800 of an active offer shown in FIG. 17. The offer presents text directing the customer to select a product to add to his purchase. The offer also provides four “buttons” which, when pressed by the customer, constitute a response requesting that the indicated product be added to his purchase. Three of the buttons are respectively labeled with the names of the product (“small cola”, “cheeseburger” and “fries”). One button labeled with a question mark indicates a mystery product that the merchant selects for the customer.

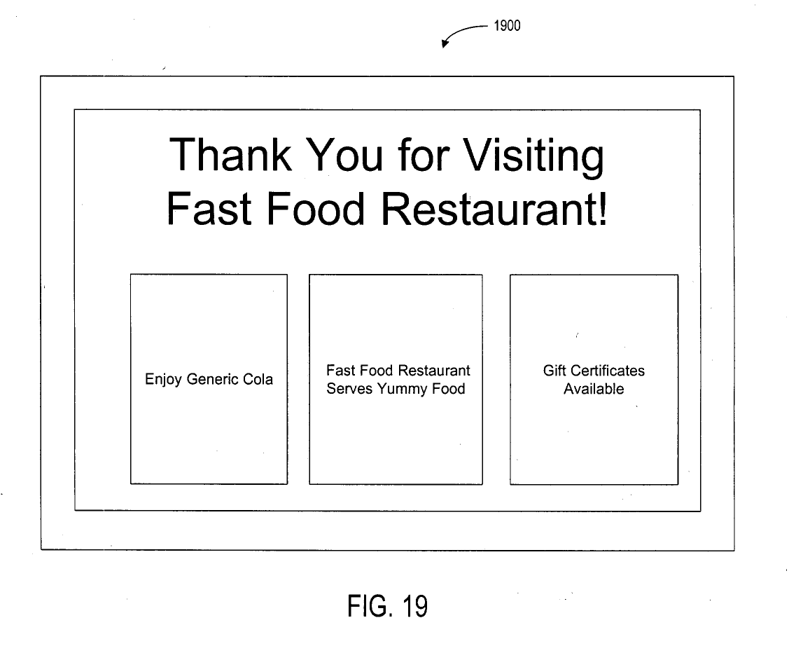

FIG. 19 depicts an example 1900 of an offer that is provided on a customer display device during a “transaction end” transaction slot. The offer provides messages to the customer, and may comprise a plurality of advertisements from one or more other merchants. As described herein, such merchants may “purchase” or “bid” on advertising space from the offer server so that the offer server provides certain offers or “impressions” on behalf of those merchants.

It is advantageous to evaluate the performance of the offer server. For example, the impact of various offers on the total time (duration) of a transaction is straightforward yet valuable to determine. Specifically, the time an offer is displayed, and the time until a provided offer is accepted, is straightforward yet valuable to determine. Such times may be used in determining, e.g., average increased revenue per unit of additional time. Furthermore, it can be advantageous to determine the overall impact of each offer type and various combinations so as to help optimize the offers and offer types individually and in all combinations and permutations and determine which generate the highest accept rates and most revenue per added second of service time.

It is generally advantageous if the offer server continually strives to increase revenue earned per customer transaction per second than is generated by the customer's initial order (e.g., the customer's order contents, item count, average check, gross and net profits, all prior to any affect of any offers). The baseline (data regarding initial orders) may be measured prior to activation of the offer server and/or by periodically gathering baseline order data by temporarily disabling offer server for a given offer. By toggling the provision of offers (and other functions of the offer server) on and off, the offer server can effectively measure all aspects of consumer behavior while the offer server is “enabled” and “disabled”. The offer server may thus effectively and accurately measure and optimize its impact on speed of service, average check, average item count, sales, gross profit, net profit and customer returns.

Similarly, the affect of an acceptance or rejection of one offer type on subsequent offers or the customer's future visits or buying habits may also be determined, allowing the performance of various offers to be improved. For example, if customers accept offer type A, the average acceptance of a subsequent offer type B during the same transaction may be determined in a known manner.

Similarly, if customers are less likely to accept a subsequent offer, then it may be determined which of the two (or more) offers should be provided or not in the current transaction slot, according to various criteria as described herein.

In one embodiment, the offer server operates in accordance with a database of rules. Various embodiments of the present invention may be implemented by merely defining and selecting appropriate rules to govern the functionality of the offer server, as will be apparent to those of skill in the art. Such rules can specify, e.g., how to identify transaction slots, how to determine whether to provide an offer during a transaction slot, how to create or select an offer, how to provide the offer.

A rule-based system appropriate for use in accordance with the present invention is disclosed in pending U.S. patent application Ser. No. 09/603,677, filed Jun. 26, 2000, entitled “METHOD AND APPARATUS FOR SELECTING A SUPPLEMENTAL PRODUCT TO OFFER FOR SALE DURING A TRANSACTION”, the entirety of which is incorporated herein by reference as part of the present disclosure.

A rule may specify how to identify a transaction slot, e.g., by identifying one or more transaction events that define the transaction slot.

A rule may specify how to determine whether to provide an offer during a transaction slot, e.g., by specifying which offers or types of offers may be provided during the transaction slot and/or a maximum number of offers or types of offers which may be provided.

A rule may specify how to create or select an offer, e.g., by specifying performance data such as the expected revenue, profitability and/or accept rate of the offer, expected increase in net profit per second, and/or specifying how the performance data is to be weighed in evaluating offers. Similarly, a rule may specify features of an offer, such as an amount of a discount on an offered product, or the relationship between the amount of a discount and the transaction total, customer identity, type of customer, etc. For example, a rule may specify that a more enticing offer (e.g. one with a greater perceived or actual value) is to be provided to a customer who has not accepted an offer earlier in the same transaction or in previous transactions. Similarly, a rule may specify that an offer with a higher average acceptance rate is to be provided to a customer who has not accepted an offer earlier in the same transaction or in previous transactions.

A rule may specify how to provide the offer, e.g., by specifying whether the offer should be provided via display or speaker and/or specifying which portion of the display the offer should occupy. The offer server may also test a variety of offer locations, types, sizes, and audio types, lengths, voice types, etc., in order to determine which are most effective, individually or collectively.

Further, any of the above-described types of rules may deliberately specify random behavior to both prevent exploitation by customers and to attempt to learn new information, which can be used for subsequent optimization. For example, an offer may be randomly selected and be provided during a random transaction slot.

As is known in the art, a rules-based system may be modified by an adaptive system in order to increase the performance of the rules-based system. An adaptive system which, among other things, may create its own rules and/or modifies rules in accordance with desired performance, and which is appropriate for use in accordance with the present invention is disclosed in pending U.S. patent application Ser. No. 09/993,228, filed Nov. 14, 2001, entitled “METHOD AND APPARATUS FOR DYNAMIC RULE AND/OR OFFER GENERATION”, the entirety of which is incorporated herein by reference as part of the present disclosure. That application discloses an apparatus and method, which permits and enables rules-based applications (such as a system that provides customers with dynamically-priced upsell offers) to become “self improving” and thus increase performance over time.

Such an adaptive system can adjust at least some of the rules in accordance with at least one “reward”, which is a measure of performance. For example, an adaptive system can modify rules such that offers that have previously proven popular when provided after a particular rejected offer are, in subsequent transactions, provided after such rejected offers.

Similarly, the number of available transaction slots could be adjusted by an adaptive system to increase performance as measured by, e.g. transaction time, acceptance rates, etc.

Furthermore, the offer might include a discount or deeper discount to increase the likelihood of acceptance.

Finally, the system might cease making active offers altogether during a given transaction if it is determined that the customer is unlikely to accept such additional offers.

The following are several examples which illustrate additional embodiments of the present invention. These examples do not constitute a definition of all possible embodiments, and those skilled in the art will understand that the present invention is applicable to many other embodiments. Further, although the following examples are briefly described for clarity, those skilled in the art will understand how to make any changes, if necessary, to the above-described apparatus and methods to accommodate these and other embodiments and applications.

According to one embodiment of the present invention, a drive through of a quick service restaurant can include several customer display devices to provide offers in visual and/or audio form. Transaction slots can be defined by the vehicle's position (e.g. at the main menu at the beginning of the drive through, at the payment window, at the food pick-up window), which in turn may be determined by vehicle weight or metal sensors on the drive path and/or data entered by cashiers into the POS terminal at particular times during the transaction.

In such an embodiment, various input from the customer can be interpreted by the order server. For example, if a customer drives away from the main window before an audio offer is completely provided, or before a visual offer is displayed for a predetermined period of time, the offer is considered to be declined. When an offer is declined in this way, the same offer may be provided again when the customer reaches the payment window by a customer display device at the payment window. Alternatively, when an offer (e.g. a product in lieu of change due) is declined in this way, a related offer (e.g. a coupon in lieu of change due) may be provided again when the customer reaches the payment window. If such an offer is not declined, then an advertisement may instead be displayed to the customer at the payment window. Alternatively, if the customer declines an offer at the main window, an offer with a deeper discount may be made at the payment window. Finally, these alternatives may be used in any combination, e.g., after a declined offer at the order window, a coupon with a deeper discount may be offered at the pickup window.

Various performance measures in such a drive through embodiment include: the time the customer waits at the main menu, at the payment window, and at the food pick-up window, or when/if the cashier accepts or declines an offer. Such times can be stored, and can be displayed to employees working at the quick service restaurant during and/or after the transaction. Similarly, such times can be displayed to the customer, possibly in conjunction with a promotion such as a free or discounted product, coupon, or entire order is earned if a particular time exceeds a predetermined threshold.

Although the present invention has been described with respect to a preferred embodiment thereof, those skilled in the art will note that various substitutions may be made to those embodiments described herein without departing from the spirit and scope of the present invention.

We claim:

1. An apparatus comprising:
means for identifying a transaction slot;
means for determining whether to provide an offer during the transaction slot;
means for creating an offer; and
means for providing the offer.

2. The apparatus of claim 1, further comprising:
a data storage device which stores a plurality of rules.

3. The apparatus of claim 2, in which the means for identifying the transaction slot comprises:
means for identifying the transaction slot based on at least one rule of the plurality of rules.

4. The apparatus of claim 2, in which the means for determining whether to provide an offer during the transaction slot comprises:
means for determining whether to provide an offer during the transaction slot based on at least one rule of the plurality of rules.

5. The apparatus of claim 2, in which the means for creating the offer comprises:
means for creating the offer based on at least one rule of the plurality of rules.

6. The apparatus of claim 2, in which the means for providing the offer comprises:
means for providing the offer based on at least one rule of the plurality of rules.

7. The apparatus of claim 1, in which the means for identifying a transaction slot comprises:
a signal detector.

8. The apparatus of claim 1, further comprising:
means for receiving a response to the offer.

9. The apparatus of claim 1, further comprising:
a recorder which records data regarding performance of the offer.

10. An apparatus comprising:
means for identifying a transaction slot;
means for determining whether to provide an offer during the transaction slot;
means for creating an offer;
means for providing the offer;
a data storage device which stores a plurality of rules; and
an adaptive system that adjusts at least some of the plurality of rules in accordance with at least one reward.

11. A method comprising:
identifying a transaction slot;
reading a plurality of rules to determine whether to provide an offer during the transaction slot;
creating an offer; and
providing the offer to a customer.

12. A method comprising:
transmitting, to a seller, a request to receive an offer for a customer;
receiving from the seller data describing an offer; and
providing the offer to the customer.

13. The method of claim 12, in which the step of transmitting is performed after receiving a predetermined signal.

14. The method of claim 12, further comprising:
charging the seller for providing the offer to the customer.
